(19) United States
(12) Patent Application Publication
(10) Pub. No.: US 2008/0006979 A1
(43) Pub. Date: Jan. 10, 2008

(54) FOLDING APPARATUS OF A PRINTING PRESS AND A METHOD FOR OPERATING THE SAME

(75) Inventors: Siegmund Echerer, Neukirchen (DE); Thomas Heidel, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/774,425

(22) Filed: Jul. 6, 2007

(30) Foreign Application Priority Data
Jul. 8, 2006 (DE) 10 2006 031 681.9

(51) Int. Cl. B65H 45/28; B41F 13/56

(52) U.S. Cl. 270/21.1; 493/22

(57) ABSTRACT

A folding apparatus of a printing press, in particular a web-fed rotary press, and a method for operating the same, is disclosed. The folding apparatus has a folding superstructure or magazine superstructure, a cutting unit located downline from the folding superstructure when viewed in the transportation direction of the substrate webs, and a cross-folding unit located downline from the cutting unit when viewed in the transportation direction of the substrate webs and/or longitudinal folding unit, where the folding superstructure includes at least one sensor to detect an anticipated cross-cutting error. On the basis of the anticipated cross-cutting error detected by the, or each, sensor, a drive for the cutting unit is governed in order to compensate for the anticipated cross-cutting error at the cutting unit.

This application claims the priority of German Patent Document No. 10 2006 031 681.9, filed Jul. 8, 2006, the disclosure of which is expressly incorporated by reference herein.

### BACKGROUND AND SUMMARY OF THE INVENTION

The invention relates to a folding apparatus of a printing press and a method for operating the same.

Folding apparatuses of printing presses are used to create folds in printed substrates, where, in the case of folding apparatuses known from the prior art, webs of a substrate are usually brought together in a folding superstructure or magazine superstructure and there deposited on top of each other in order to then take the collected webs to a first longitudinal folding unit having at least one former board in order to create a longitudinal fold in the webs. Starting from the first longitudinal folding unit, the webs are taken towards a cutting unit. In the area of the cutting unit, copies are separated from the webs with a longitudinal fold by cross cutting. Positioned after the cutting unit there is usually a cross-folding unit which comprises at least one tucker blade cylinder and a jaw cylinder. Copies separated at the cutting unit are moved towards the jaw cylinder with the aid of the tucker blade cylinder. The separated copies which are moved by the tucker blade towards the jaw cylinder are transferred by the tucker blade cylinder to the jaw cylinder as a first cross fold is formed. Additional second cross folds can be formed between the tucker blade cylinder and a gripper cylinder which cooperates with the tucker blade cylinder. Starting from the cross-folding unit, the copies furnished thus with one longitudinal fold and with at least one cross fold reach the area of a second longitudinal folding unit which usually comprises several folding tables. In the area of the folding tables, second longitudinal folds are created in the already folded copies which run parallel to the longitudinal fold formed in the first longitudinal folding unit.

Folding apparatuses are also known without former boards or first longitudinal folding units where the substrate webs starting from the folding superstructure or magazine structure are taken directly to the cutting unit.

Furthermore, folding apparatuses are known which have no cross-folding unit in which consequently copies separated from the substrate webs in the area of the cutting unit are collected on a collecting cylinder and taken directly to the second longitudinal folding unit.

The folding superstructure or magazine superstructure usually comprises several offset bars where the paths of the substrate webs can be lengthened or shortened using the offset bars in order to compensate for an anticipated cross-cutting error which can occur at the cutting unit. The anticipated cross-cutting error is detected with the aid of sensors which are assigned to the folding superstructure or magazine superstructure, in particular to the offset bars of the same. If, on the basis of the anticipated cross-cutting error detected by the sensors assigned to the folding superstructure the offset bars are governed, it follows necessarily that macules are created in the area of the cutting unit since no influence can be exerted on the section of the substrate webs which has already passed the sensors. This is disadvantageous.

The object of the present invention is to create a novel folding apparatus of a printing press and a method for operating the same with which fewer macules are created in the area of the cutting unit.

In accordance with the invention, on the basis of the anticipated cross-cutting error detected by the, or each, sensor, a drive to the cutting unit is governed to compensate for the anticipated cross-cutting error at the cutting unit.

In the meaning of the present invention it is provided for the first time to govern the drive for the cutting unit on the basis of the anticipated error detected with the assistance of at least one sensor in the area of the folding superstructure or magazine superstructure which can occur at the cutting unit which serves to separate the copies from the substrate webs, in order to compensate for the anticipated cross-cutting error directly at the cutting unit. On the basis of the anticipated cross-cutting error, an offset is sent to the control signal for the drive for the cutting unit in order to compensate for the anticipated cross-cutting error directly at the cutting unit. The creation of macules in the area of the cutting unit can thereby be clearly reduced compared with the prior art. A particular advantage lies in the compensation of all cross-cutting errors occurring before the longitudinal cut of the substrate web. These errors which continue to exist on every single ribbon following the longitudinal cut are compensated for at the same time by governing the drive for the cutting unit without the occurrence of macules. This eliminates observation of the individual ribbons and it is sufficient to observe a reference ribbon to determine the position error.

Preferably, on the basis of the anticipated cross-cutting error detected by the, or each, sensor, all drives for the component groups of the folding apparatus which, when viewed in the transport direction of the substrate webs or of the copies, are located downline from the cutting unit, are furthermore governed.

In accordance with an advantageous further development of the invention, a sensor is assigned to a tucker blade cylinder of a cross-folding unit located, when viewed in the transportation direction of the substrate webs or the copies, downline from the cutting unit in order to determine the actual cross-cutting error relative to the tucker blade system of the tucker blade cylinder, where depending on this actual cross-cutting error a drive for the tucker blade system is governed in order to compensate for the actual cross-cutting error.

Preferred further developments of the invention become clear from the subsequent description. One embodiment of the invention, without being restricted thereto, is explained in more detail using the drawing.

### BRIEF DESCRIPTION OF THE DRAWING

FIG. 1 shows a schematized representation of a folding apparatus of a printing press in accordance with the invention.

### DETAILED DESCRIPTION OF THE DRAWING

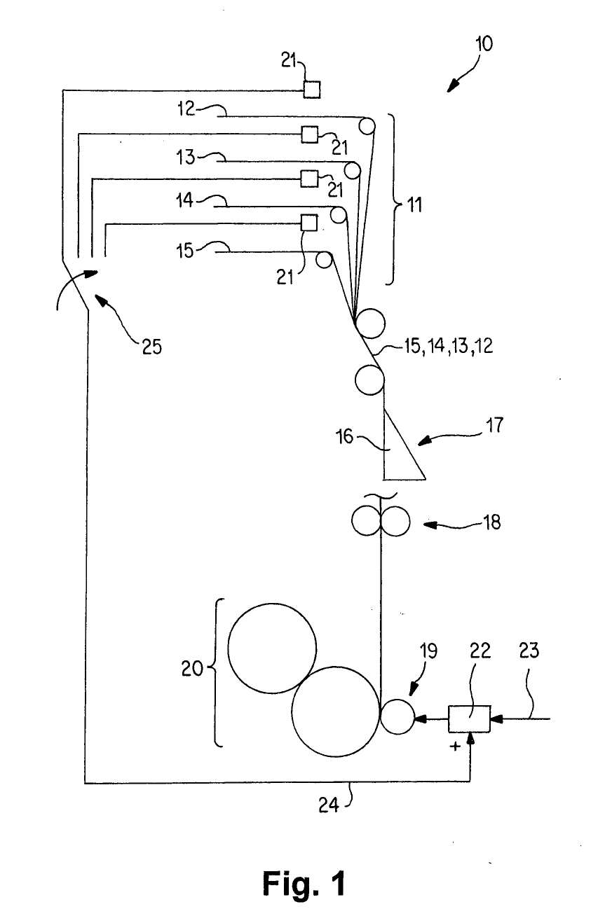

FIG. 1 shows a highly schematized representation of a folding apparatus 10 which comprises a folding superstructure 11, where in accordance with FIG. 1 four substrate webs 12, 13, 14 and 15 are brought together and placed on top of each other. In accordance with FIG. 1, the substrate webs 12, 13, 14 and 15 brought together in the area of the folding superstructure are taken to a former board 16 of a longitudinal folding unit 17 to form a longitudinal fold in the substrate webs 12, 13, 14 and 15. The substrate webs 12 to 15 which have been given a longitudinal fold then pass a cross-perforation unit 18 and after the cross-perforation unit 18 a cutting unit 19 to separate copies, by cross-cutting, from the substrate webs 12, 13, 14 and 15 which have been given a longitudinal fold.

In accordance with FIG. 1, a cross-folding unit 20 follows after the cutting unit 19 to form at least one cross fold in the copies separated from the substrate webs. The structure of such cross-folding units is familiar to the person skilled in the art addressed here and requires no further explanation. A second longitudinal folding unit, not shown, can follow on the cross-folding unit 20 to create additional longitudinal folds in the copies, which have already been given one longitudinal fold and at least one cross fold, which run parallel to the longitudinal folds created in the former board 16 of the longitudinal folding unit 17.

In accordance with FIG. 1, at least one sensor 21 configured as a camera is assigned to each substrate web 12, 13, 14 and 15 in the area of the folding superstructure. Using the sensors 21, an anticipated cross-cutting error can be detected in the area of the folding superstructure 11 which can occur in the cross-cutting of the substrate webs 12 to 15 in the area of the cutting unit 19.

In the sense of the present invention, on the basis of the anticipated cross-cutting error detected by the, or each, sensor 21, a drive 22 for the cutting unit 19 is governed in order to compensate for the anticipated cross-cutting error at the cutting unit 19. The anticipated cross-cutting error detected by the, or each, sensor 21 is superimposed on a control signal 23 for the drive 22 of the cutting unit 19 in the sense of an offset 24.

In accordance with FIG. 1, a sensor 21 to detect the anticipated cross-cutting error is assigned to each substrate web 12, 13, 14 and 15, where, however, one substrate web is defined as a reference web and solely the anticipated cross-cutting error determined by the sensor 21 assigned to the reference web is used to govern the drive 22 for the cutting unit 19. In the embodiment from FIG. 1, the substrate material web 12 is defined as the reference web, where, contingent upon the position of the switch 25, the measurand of the sensor 21 which is assigned to the reference ribbon 12 is used to superimpose an offset on the control signal 23 for the drive 22 of the cutting unit 19. It should be pointed out that each of the substrate webs 12 to 15 can be defined as the reference ribbon. Then only the switch 25 is moved to a switching position in which the anticipated cross-cutting error determined by the sensor assigned to the reference ribbon is used to prepare the offset.

In accordance with an advantageous development of the present invention, the anticipated and detected cross-cutting error which can occur at the cutting unit 19 is used not only to govern the drive 22 of the cutting unit 19 but also to govern offset bars, not shown, positioned in the area of the folding superstructure 11 which act to lengthen or to shorten the paths of the substrate material webs 12 to 15. In this case, by governing the offset bars in the area of the folding superstructure 11, rough compensation of the anticipated cross-cutting error is possible; fine compensation is carried out by governing the drive 22 of the cutting unit 19.

On the basis of the anticipated cross-cutting error detected by a sensor 21, not only is the drive 22 of the cutting unit 19 governed, but preferably all drives of the component groups of the folding apparatus are governed, depending on the anticipated cross-cutting error, which when viewed in the transportation direction of the substrate webs or the copies are located downline from the cutting unit 19. Among the drives involved are the drives for the component groups of the cross-folding unit 20.

In accordance with an advantageous further development of the invention, a further sensor, not shown, can be assigned to a tucker blade cylinder of the cross-folding unit 20 which when viewed in the transportation direction of the substrate webs or of the copies separated from the substrate material webs is located downline from the cutting unit 19 to determine the actual cross-cutting error of the cutting unit 19 relative to a tucker blade system of the tucker blade cylinder. The actual cross-cutting error determined by this sensor can then be used to govern a drive for the tucker blade system of the tucker blade cylinder in order to compensate for the actual cross-cutting error of the cutting unit 19 in the area of the cross-folding unit.

Reference numeral list:
10 Folding apparatus
11 Folding superstructure
12 Substrate web
13 Substrate web
14 Substrate web
15 Substrate web
16 Former board
17 Longitudinal folding unit
18 Cross-perforation unit
19 Cutting unit
20 Cross-folding unit
21 Sensor
22 Drive
23 Control signal
24 Offset
25 Switch

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a folding apparatus of a printing press, in particular a web-fed rotary press, which has a folding superstructure or magazine superstructure, a cutting unit located downline from the folding superstructure when viewed in a transportation direction of substrate webs, and a cross-folding unit and/or a longitudinal folding unit located downline from the cutting unit when viewed in the transportation direction of the substrate webs, wherein the folding superstructure includes at least one sensor for detecting an anticipated cross-cutting error, and wherein on a basis of the anticipated cross-cutting error detected by the, or each, sensor, a drive for the cutting unit is governed in order to compensate for the anticipated cross-cutting error at the cutting unit.

2. The method according to claim 1, wherein on the basis of the anticipated cross-cutting error detected by the, or each, sensor, offset bars of the folding structure are further governed in order to compensate in advance at least partially for the anticipated cross-cutting error at the offset bars.

3. The method according to claim 1, wherein in an area of the folding superstructure, for each individual substrate web which is brought together in the folding superstructure, at least one sensor for detecting the anticipated cross-cutting error is assigned to this substrate web where one of the substrate webs brought together is defined as a reference web and where the anticipated cross-cutting error determined at the reference web is used to govern the drive for the cutting unit.

4. The method according to claim 1, wherein on the basis of the anticipated cross-cutting error detected by the, or each, sensor, all drives for component groups of the folding apparatus are further governed which, when viewed in the transportation direction of the substrate webs, are located downline from the cutting unit.

5. The method according to claim 1, wherein a sensor is assigned to a tucker blade cylinder of a cross-folding unit located downline from the cutting unit when viewed in the transportation direction of the substrate webs in order to determine an actual cross-cutting error relative to a tucker blade system of the tucker blade cylinder and, depending on this actual cross-cutting error, a drive for the tucker blade system is governed to compensate for the actual cross-cutting error.

6. A method for operating a folding apparatus of a printing press, comprising the steps of:
detecting an anticipated cross-cutting error of a cutting unit by a sensor in a folding superstructure, wherein the cutting unit is located downline from the folding superstructure in a transportation direction of a substrate web; and
governing a drive of the cutting unit based on the anticipated cross-cutting error detected by the sensor to compensate for the anticipated cross-cutting error at the cutting unit.

7. The method according to claim 6, wherein the sensor provides an offset signal to the drive of the cutting unit.

8. The method according to claim 7, wherein the offset signal is superimposed on a control signal for the drive.

9. The method according to claim 6, wherein the sensor is assigned to the substrate web.

10. The method according to claim 6, further comprising the steps of detecting an actual cross-cutting error of the cutting unit and governing a cross-folding unit based on the actual cross-cutting error, wherein the cross-folding unit is located downline from the cutting unit in the transportation direction of the substrate web.

11. The method according to claim 6, wherein a plurality of substrate webs are folded in the folding apparatus and wherein a sensor is assigned to each of the substrate webs in the folding superstructure.

12. The method according to claim 11, wherein a one of the plurality of substrate webs is assigned as a reference web and wherein the drive of the cutting unit is governed based only on an anticipated cross-cutting error detected by the sensor assigned to the reference web.

13. A folding apparatus of a printing press, comprising:
a folding superstructure including a sensor; and
a cutting unit operatively coupled to the folding superstructure, wherein the cutting unit is located downline from the folding superstructure in a transportation direction of a substrate web;
wherein an anticipated cross-cutting error of the cutting unit is detectable by the sensor of the folding superstructure and wherein a drive of the cutting unit is governable based on the anticipated cross-cutting error detectable by the sensor to compensate for the anticipated cross-cutting error at the cutting unit.

14. The folding apparatus according to claim 13, wherein the sensor provides an offset signal to the drive of the cutting unit.

15. The folding apparatus according to claim 14, wherein the offset signal is superimposed on a control signal for the drive.

16. The folding apparatus according to claim 13, wherein the sensor is assigned to the substrate web.

17. The folding apparatus according to claim 13, wherein an actual cross-cutting error of the cutting unit is detectable by a sensor associated with a cross-folding unit, wherein the cross-folding unit is operatively coupled to the cutting unit and is located downline from the cutting unit in the transportation direction of the substrate web, and wherein the cross-folding unit is governable based on the actual cross-cutting error.

18. The folding apparatus according to claim 13, wherein a plurality of substrate webs are foldable in the folding apparatus and wherein a sensor is assigned to each of the substrate webs in the folding superstructure.

19. The folding apparatus according to claim 18, wherein a one of the plurality of substrate webs is assigned as a reference web and wherein the drive of the cutting unit is governable based only on an anticipated cross-cutting error detectable by the sensor assigned to the reference web.

20. The folding apparatus according to claim 19, further comprising a switch and wherein the anticipated cross-cutting error detectable by the sensor assigned to the reference web is provided through the switch to the drive.
